(19) United States
(12) Patent Application Publication
(10) Pub. No.: US 2002/0052426 A1
(43) Pub. Date: May 2, 2002

(54) E.V.A. furniture

(76) Inventors: Lawrence J. Tarantino, Millstone, NJ (US); Sharon A. Tarantino, Millstone, NJ (US)

Correspondence Address: Lawrence J. Tarantino, 1423 Main Street, Millstone, NJ, 08844, US

(21) Appl. No.: 10/004,021

(22) Filed: Nov. 2, 2001

Related U.S. Application Data
(60) Provisional application No. 60/245,344, filed on Nov. 2, 2000.

(51) Int. Cl. C08F 2/00; C08F 118/02

(52) U.S. Cl. 521/142; 526/319

(57) ABSTRACT

The invention herein disclosed is furniture comprised of a closed-cell foam known as ethylene vinyl acetate, hereafter known as E.V.A. This new use of E.V.A. material provides structural integrity when various shapes are laminated together. The designs are based upon modular units that provide efficiency in fabrication as well as versatility in use.

### BACKGROUND OF THE INVENTION

The present invention relates generally to modular furniture and, more particularly, to new and improved modular furniture designs using ethylene vinyl acetate as the material for the construction of furniture.

### DESCRIPTION OF THE RELATED ART

Traditionally, furniture designs have utilized wood, metal or a foam core to provide stability and structure for the furniture form. The furniture frames are typically covered with foam padding and then fabric upholstery is stretched over the padding. The inventors are unaware of any furniture where the foam is the structure, as well as, the exposed final finish. Additionally, other furniture designs with laminated materials do not offer both structural capabilities and at the same time a soft resilient seating surface.

### SUMMARY OF THE INVENTION

The proposed furniture in accordance with the invention can be produced in a wide variety of forms using ethylene vinyl acetate, herein referred to as E.V.A.

E.V.A. is a closed cell, dense resilient foam that is unique in the field of present furniture design applications. It is commonly used in the production of mouse pads, shoes, automotive parts, athletic equipment padding and mats, as well as children's two-dimensional toys. However, it has not been found that E.V.A. has been used in the construction of furniture design. The development of the furniture design potential began with the understanding that the unique physical properties of E.V.A. are structurally capable of supporting human weight and thereby, a providing useful piece of furniture. Because of the material's soft characteristic, the design shape may have square rectangular, sharp edges without the usual comfort and safety concerns in chairs of other typical materials, i.e. wood, metal or plastic. Additionally, E.V.A. is safe, durable, washable, non-toxic, non-flammable, and can be protected from ultraviolet sunrays. E.V.A. can be produced in unlimited colors and does not require covering or additional coating or finishing. Other foam chairs presenting available have a plastic coating and/or fabric covering. These unique physical properties of the E.V.A. material provide opportunities in furniture design for children, as well as adults. The furniture fabrication process begins with manufacturing the E.V.A. raw material in various densities that are identified by the manufacturing industry in weight. The inventors have determined that the appropriate density

### SUMMARY OF THE INVENTION

for the production of chairs is 40 lbs. because it provides adequate strength to support weight and durability. E.V.A. is manufactured in a thickness of approximately 120 mm and is referred to in the industry as a bun. The inventors have developed a formula that relates the thickness of E.V.A. sheets and proportion of the furniture to the user, i.e. size and weight of person. The thickness of the E.V.A. sheet=1 unit and 3 units=1module. These units and modules can increase or decrease depending upon the size chair desired. In the case of a child's chair, the unit size (E.V.A. sheet thickness) would be approximately 30 mm and an adult full-scale chair would be 40 mm.

Once the exact thickness of the E.V.A. has been determined, the bun is trimmed into sheets and then the shapes are die-cut into a nested pattern. The nested pattern provides a cost-effective method of fabrication with minimal material waste. The die-cut E.V.A. pieces are then laminated together with adhesive and then grinded to a smooth finish.

Because the design is based upon a modular formula the chairs can be easily stacked in various configurations. Also, because the E.V.A. has a smooth suede-like finish it provides friction that keeps the stacking chairs in place. The interlocking stacking options are particularly useful for a child's chair where up to eight (8) chairs can be safely stacked on top of each other. Also, the child's chair is light enough (approximately 3 lbs.) so that a child can carry it while not damaging anything or anyone it his or her path.

### DESCRIPTION OF THE DRAWINGS

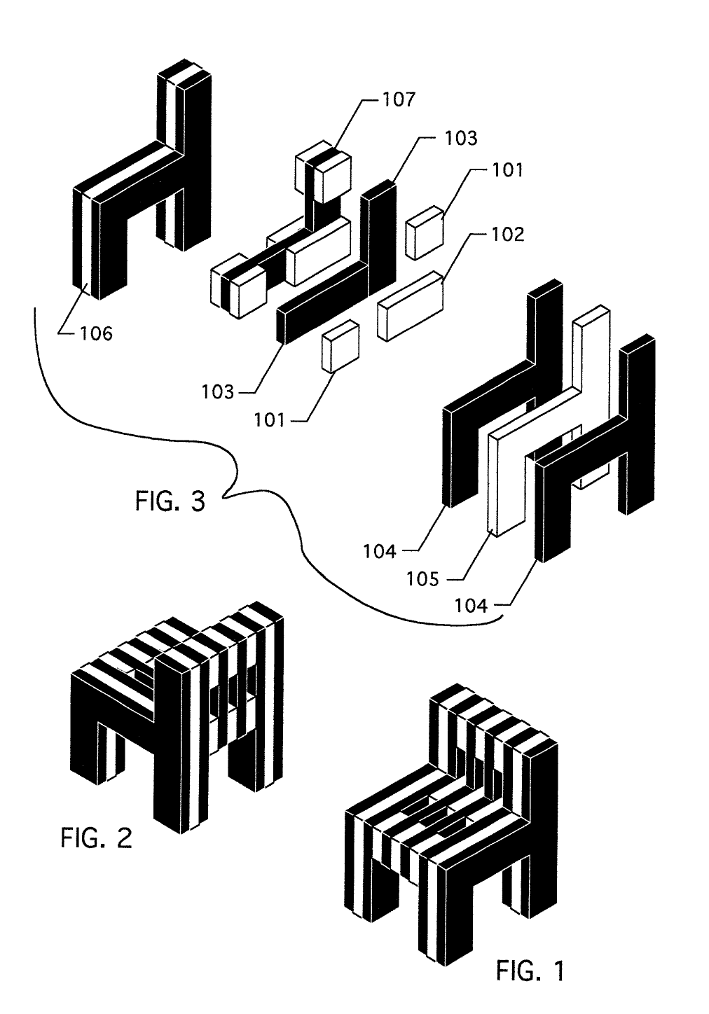

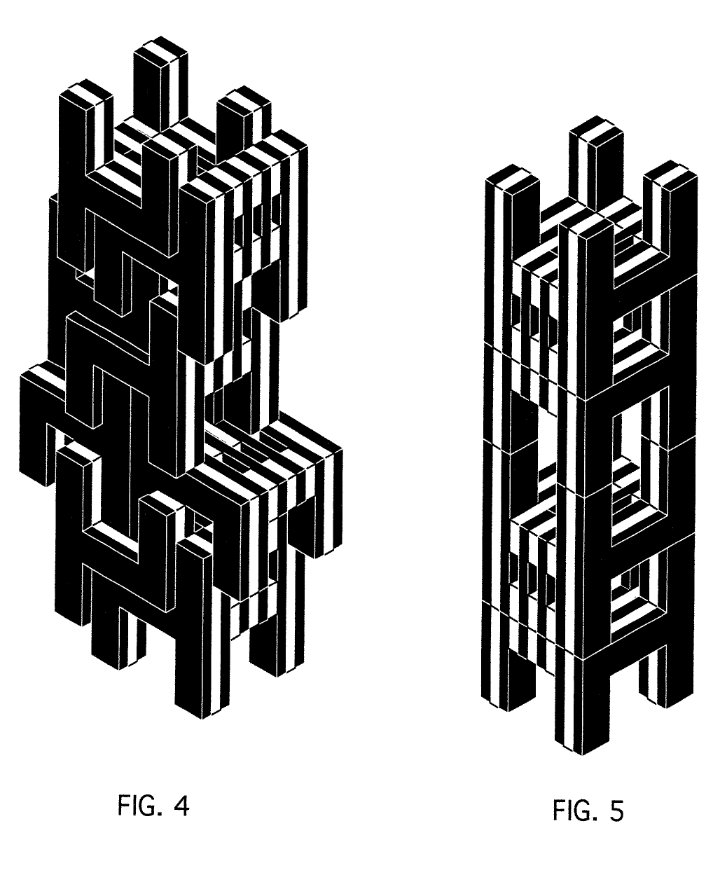

Drawing Sheet 1-3 represents two perspective views (FIG. 1 and FIG. 2) of a child's chair design option and one exploded view (FIG. 3). FIG. 1 is a front and side view perspective of a chair design, according to the present invention. FIG. 2 is a back and reverse side view perspective of a chair design, according to the present invention. FIG. 3 is an isometric drawing, partially exploded view of one preferred embodiment of an article of furniture according to the present invention. Reference #101-107 represent individual E.V.A. pieces that are required in order to fabricate one chair. The E.V.A. layered pieces represented in FIG. 3 are 30 mm thick and the black and white pieces represent alternating colors. The attachment method of E.V.A. layers is by adhesive lamination.

Drawing Sheet 2-3 represents one stacking option (FIG. 4) with eight (8) interlocking chairs, as illustrated on Drawing Sheet 1-3. FIG. 5 represents another stacking option with the same four (4) chairs.

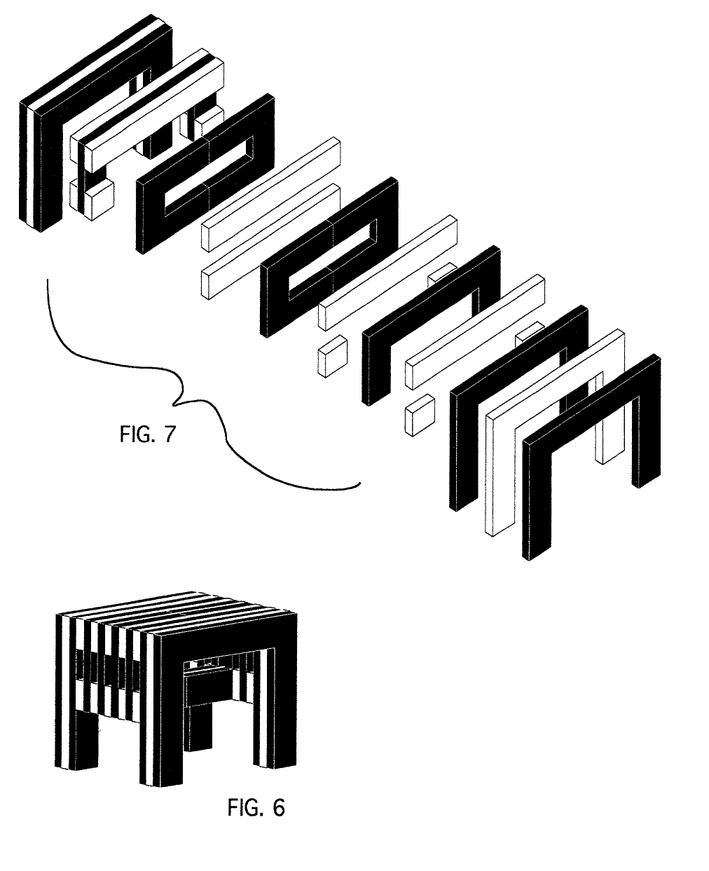

Drawing Sheet 3-3 represents a front and side perspective view (FIG. 6) of a child's table design option according to the present invention. The reverse side and back views are identical. FIG. 7 is an isometric drawing, partially exploded view with representing individual E.V.A. pieces required in order to fabricate one table. The E.V.A. layered pieces represented in FIG. 7 are 30 mm thick and the black and white pieces represent alternating colors. The attachment method of E.V.A. layers is by adhesive lamination.

What is claimed is as follows:

1. The modularly designed furniture as comprised of ethylene vinyl acetate (E.V.A.) which provides structural integrity that is suitable for various shapes and stacking possibilities.

2. The ethylene vinyl acetate (E.V.A.) is cut into sheets, the furniture shapes are cut and then the foam is laminated together with adhesive.

3. The ethylene vinyl acetate (E.V.A.) has a density range of between 35 and 45 lbs.

4. The ethylene vinyl acetate (E.V.A.) furniture is safe, durable, washable, non-toxic, non-flammable and can be protected from ultra-violet rays.
